(19) United States
(12) Patent Application Publication
(10) Pub. No.: US 2025/0232309 A1
(43) Pub. Date: Jul. 17, 2025

(54) PAYMENT NETWORK INTENT MONEY MANAGER

(71) Applicant: Visa International Service Association, San Francisco, CA (US)

(72) Inventor: Hunny Huria, Singapore (SG)

(73) Assignee: Visa International Service Association, San Francisco, CA (US)

(21) Appl. No.: 18/414,594

(22) Filed: Jan. 17, 2024

(51) Int. Cl. G06Q 20/40; G06Q 20/10; G06Q 20/34; G06Q 20/36

(52) U.S. Cl. CPC G06Q 20/405; G06Q 20/342; G06Q 20/351; G06Q 2220/00

(57) ABSTRACT

Disclosed are systems and methods to manage financial transactions based on an intent-to-spend fungible funds based on a set of rules. In one aspect, a computer-implemented method receives, by an intent money manager computer (IMMC), a message from an intent-issuing entity, the message including a request to create an intent-to-spend account and a set of rules defining a spending methodology for fungible funds of the intent-to-spend account. The IMMC creates the intent-to-spend account based on the message, and sends, based on the creating, a notification to a participating financial institution, where the notification includes information relating to the intent-to-spend account and the set of rules defining the spending methodology for the fungible funds deposited in the intent-to-spend account, and where the participating financial institution, upon receipt of the notification, enables users to enroll in an intent-to-spend program associated with the intent-to-spend account via at least one banking channel.

### TECHNICAL FIELD

The following disclosure relates generally to an intent money manager computer that enables an entity to share and manage fungible funds for use by onboarded clients, where the fungible funds are for use by the onboarded clients according to an entity-issued intent.

### SUMMARY

In part, in one aspect, the present disclosure provides a computer-implemented method for managing financial transactions based on an intent-to-spend fungible funds based on a set of rules, the computer-implemented method including receiving, by an intent money manager computer, a message from an intent-issuing entity, the message including a request to create an intent-to-spend account and a set of rules defining a spending methodology for fungible funds deposited in the intent-to-spend account; creating, by the intent money manager computer, the intent-to-spend account, the intent-to-spend account includes a unique intent identification based on the set of rules; sending, by the intent money manager computer, the unique intent identification to the intent-issuing entity; sending, by the intent money manager computer, a notification to a participating financial institution, the notification including information relating to the intent-to-spend account and the set of rules defining the spending methodology for the fungible funds deposited in the intent-to-spend account; receiving, by the intent money manager computer, encrypted identification information for a client onboarded by the participating financial institution to participate in an intent-to-spend program associated with the intent-to-spend account, information associated with a payment instrument of the client, the payment instrument is linked to the intent-to-spend account, and information associated with the intent-to-spend account and the set of rules defining the spending methodology; validating, by the intent money manager computer, the encrypted identification information; based on a successful validation: creating, by the intent money manager computer, a prepaid payment instrument for the client; funding, by the intent money manager computer, the prepaid payment instrument up to an amount specified by the intent-issuing entity based on the unique intent identification; posting, by the intent money manager computer, the amount to the intent-to-spend account created by the intent money manager computer; and sending, by the intent money manager computer, information associated with the prepaid payment instrument and the amount to the participating financial institution.

In part, in one aspect, the present disclosure provides a computer-implemented method for creating an intent-to-spend account, the computer-implemented method including receiving, by an intent money manager computer, a message from an intent-issuing entity, the message including a request to create an intent-to-spend account and a set of rules defining a spending methodology for fungible funds deposited in the intent-to-spend account; creating, by the intent money manager computer, the intent-to-spend account based on the message; and sending, by the intent money manager computer and based on the creating of the intent-to-spend account, a notification to a participating financial institution, the notification includes information relating to the intent-to-spend account and the set of rules defining the spending methodology for the fungible funds deposited in the intent-to-spend account, and the participating financial institution, upon receipt of the notification, enables users to enroll in an intent-to-spend program associated with the intent-to-spend account via at least one banking channel.

In part, in one aspect, the present disclosure provides a computer-implemented method for creating a prepaid payment instrument for use according to an intent-to-spend fungible funds based on a set of rules, the computer-implemented method including based on a participating financial institution receiving a notification of an intent-to-spend account being created and enabling users to enroll in an intent-to-spend program associated with the intent-to-spend account: receiving, by an intent money manager computer, encrypted identification information of an enrolled client, information associated with a payment instrument of the enrolled client, the payment instrument is linked to the intent-to-spend account, and information associated with the intent-to-spend account and a set of rules defining a spending methodology for fungible funds deposited in the intent-to-spend account; validating, by the intent money manager computer, the encrypted identification information of the enrolled client; based on a successful validation: creating, by the intent money manager computer, a prepaid payment instrument for the enrolled client according to the information associated with the intent-to-spend account and the set of rules defining the spending methodology for fungible funds deposited in the intent-to-spend account; funding, by the intent money manager computer, the prepaid payment instrument up to an amount specified by an intent-issuing entity; posting, by the intent money manager computer, the amount to the intent-to-spend account created by the intent money manager computer; and sending, by the intent money manager computer, information associated with the prepaid payment instrument and the amount to the participating financial institution.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

The systems and methods disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 is a swimlane diagram illustrating a process of creating an intent-to-spend account, according to at least one aspect of the present disclosure.

FIG. 2 is a swimlane diagram illustrating a process of linking an existing payment instrument with an intent-to-spend account and creating a virtual prepaid instrument for which fungible funds of the intent-to-spend account may be deposited, according to at least one aspect of the present disclosure.

FIG. 3 is a flow diagram illustrating a payment processing method with an intent money manager computer (IMMC), according to at least one aspect of the present disclosure.

FIG. 4 illustrates a method for managing financial transactions based on an intent-to-spend fungible funds based on a set of rules, according to at least one aspect of the present disclosure.

FIG. 5 illustrates a method for creating an intent-to-spend account, according to at least one aspect of the present disclosure.

FIG. 6 illustrates a method for creating a prepaid payment instrument for use according to an intent-to-spend fungible funds based on a set of rules, according to at least one aspect of the present disclosure.

FIG. 7 is a block diagram of a computer apparatus with data processing subsystems or components, according to at least one aspect of the present disclosure.

FIG. 8 is a diagrammatic representation of an example computer system that includes a host machine within which a set of instructions to perform any one or more of the methodologies discussed herein may be executed, according to at least one aspect of the present disclosure.

### DESCRIPTION

The following disclosure may provide exemplary systems, devices, and methods for conducting a financial transaction and related activities. Although reference may be made to such financial transactions in the examples provided below, aspects are not so limited. That is, the systems, methods, and apparatuses may be utilized for any suitable purpose.

Before discussing specific embodiments, aspects, or examples, some descriptions of terms used herein are provided below.

“Account credentials” may include any information that identifies an account and allows a payment processor to verify that a device, person, or entity has permission to access the account. For example, account credentials may include an account identifier (e.g., a PAN), a token (e.g., account identifier substitute), an expiration date, a cryptogram, a verification value (e.g., card verification value (CVV)), personal information associated with an account (e.g., address, etc.), an account alias, or any combination thereof. Account credentials may be static or dynamic such that they change over time. Further, in some embodiments or aspects, the account credentials may include information that is both static and dynamic. For example, an account identifier and expiration date may be static but a cryptogram may be dynamic and change for each transaction. Further, in some embodiments or aspects, some or all of the account credentials may be stored in a secure memory of a user device. The secure memory of the user device may be configured such that the data stored in the secure memory may not be directly accessible by outside applications and a payment application associated with the secure memory may be accessed to obtain the credentials stored on the secure memory. Accordingly, a mobile application may interface with a payment application in order to gain access to payment credentials stored on the secure memory.

Further, the term “account credential,” “account number,” or “payment credential” may refer to any suitable information associated with an account (e.g., a payment account and/or payment device associated with the account). Such information may be directly related to the account or may be derived from information related to the account. Examples of account information may include a PAN (primary account number or “account number”), user name, expiration date, CVV (card verification value), dCVV (dynamic card verification value), CVV2 (card verification value 2), CVC3 card verification values, etc. Payment credentials may be any information that identifies or is associated with a payment account. Payment credentials may be provided in order to make a payment from a payment account. Payment credentials can also include a user name, an expiration date, a gift card number or code, and any other suitable information.

An “acquirer” may refer to an entity licensed by the transaction service provider and/or approved by the transaction service provider to originate transactions (e.g., payment transactions) using a portable financial device associated with the transaction service provider. Acquirer may also refer to one or more computer systems operated by or on behalf of an acquirer, such as a server computer executing one or more software applications (e.g., “acquirer server”). An “acquirer” may be a merchant bank, or in some cases, the merchant system may be the acquirer. The transactions may include original credit transactions (OCTs) and account funding transactions (AFTs). The acquirer may be authorized by the transaction service provider to sign merchants of service providers to originate transactions using a portable financial device of the transaction service provider. The acquirer may contract with payment facilitators to enable the facilitators to sponsor merchants. The acquirer may monitor compliance of the payment facilitators in accordance with regulations of the transaction service provider. The acquirer may conduct due diligence of payment facilitators and ensure that proper due diligence occurs before signing a sponsored merchant. Acquirers may be liable for all transaction service provider programs that they operate or sponsor. Acquirers may be responsible for the acts of its payment facilitators and the merchants it or its payment facilitators sponsor.

The term “acquirer” typically is a business entity (e.g., a commercial bank) that has a business relationship with a particular merchant or other entity. Some entities can perform both issuer and acquirer functions. Some embodiments or aspects may encompass such single entity issuer-acquirers. An acquirer may operate an acquirer computer, which can also be generically referred to as a “transport computer”.

As used herein, the term “computing device” or “computer device” may refer to one or more electronic devices that are configured to directly or indirectly communicate with or over one or more networks. A computing device may be a mobile device, a desktop computer, and/or the like. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing device may not be a mobile device, such as a desktop computer. Furthermore, the term “computer” may refer to any computing device that includes the necessary components to send, receive, process, and/or output data, and normally includes a display device, a processor, a memory, an input device, a network interface, and/or the like.

A “credential” may be any suitable information that serves as reliable evidence of worth, ownership, identity, or authority. A credential may be a string of numbers, letters, or any other suitable characters that may be present or contained in any object or document that can serve as confirmation. Examples of credentials include value credentials, identification cards, certified documents, access cards, passcodes and other login information, etc.

As used herein, an “electronic wallet,” “digital wallet” or “mobile wallet” can store user profile information, payment information (including tokens and/or payment cards), bank account information, and/or the like and can be used in a variety of transactions, such as but not limited to eCommerce, social networks, money transfer/personal payments, mobile commerce, proximity payments, gaming, and/or the like for retail purchases, digital goods purchases, utility payments, purchasing games or gaming credits from gaming websites, transferring funds between users, and/or the like.

An “issuer” can include a payment account issuer. The payment account (which may be associated with one or more payment devices) may refer to any suitable payment account (e.g., credit card account, a checking account, a savings account, a merchant account assigned to a consumer, or a prepaid account), an employment account, an identification account, an enrollment account (e.g., a student account), etc.

As used herein, the term “merchant” may refer to one or more individuals or entities (e.g., operators of retail businesses that provide goods and/or services, and/or access to goods and/or services, to a user (e.g., a customer, a consumer, a customer of the merchant, and/or the like) based on a transaction (e.g., a payment transaction)). As used herein “merchant system” may refer to one or more computer systems operated by or on behalf of a merchant, such as a server computer executing one or more software applications.

A “payment network” may refer to an electronic payment system used to accept, transmit, or process transactions made by payment devices for money, goods, or services. The payment network may transfer information and funds among issuers, acquirers, merchants, and payment device users. One illustrative non-limiting example of a payment network is VisaNet, which is operated by Visa, Inc.

A “payment processing network” may refer to a system that receives accumulated transaction information from the gateway processing service, typically at a fixed time each day, and performs a settlement process. Settlement may involve posting the transactions to the accounts associated with the payment devices used for the transactions and calculating the net debit or credit position of each user of the payment devices. An exemplary payment processing network is Interlink®.

As used herein, the term “server” may include one or more computing devices which can be individual, stand-alone machines located at the same or different locations, may be owned or operated by the same or different entities, and may further be one or more clusters of distributed computers or “virtual” machines housed within a datacenter. It should be understood and appreciated by a person of skill in the art that functions performed by one “server” can be spread across multiple disparate computing devices for various reasons. As used herein, a “server” is intended to refer to all such scenarios and should not be construed or limited to one specific configuration. Further, a server as described herein may, but need not, reside at (or be operated by) a merchant, a payment network, a financial institution, a healthcare provider, a social media provider, a government agency, or agents of any of the aforementioned entities. The term “server” may also refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, e.g., point-of-sale devices, directly or indirectly communicating in the network environment may constitute a “system,” such as a merchant's point-of-sale system. Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “system” may refer to one or more computing devices or combinations of computing devices (e.g., processors, servers, client devices, software applications, components of such, and/or the like).

The term “transaction data” may include any data associated with one or more transactions. In some embodiments or aspects, the transaction data may merely include an account identifier (e.g., a PAN) or payment token. Alternatively, in other embodiments or aspects, the transaction data may include any information generated, stored, or associated with a merchant, consumer, account, or any other related information to a transaction. For example, transaction data may include data in an authorization request message that is generated in response to a payment transaction being initiated by a consumer with a merchant. Alternatively, transaction data may include information associated with one or more transactions that have been previously processed and the transaction information has been stored on a merchant database or other merchant computer. The transaction data may include an account identifier associated with the payment instrument used to initiate the transaction, consumer personal information, products or services purchased, or any other information that may be relevant or suitable for transaction processing. Additionally, the transaction information may include a payment token or other tokenized or masked account identifier substitute that may be used to complete a transaction and protect the underlying account information of the consumer.

A “user” may include an individual. In some embodiments or aspects, a user may be associated with one or more personal accounts and/or mobile devices. The user may also be referred to as a cardholder, account holder, or consumer.

A “user device” is an electronic device that may be transported and/or operated by a user. A user device may provide remote communication capabilities to a network. The user device may be configured to transmit and receive data or communications to and from other devices. In some embodiments or aspects, the user device may be portable. Examples of user devices may include mobile phones (e.g., smart phones, cellular phones, etc.), PDAs, portable media players, wearable electronic devices (e.g., smart watches, fitness bands, ankle bracelets, rings, earrings, etc.), electronic reader devices, and portable computing devices (e.g., laptops, netbooks, ultrabooks, etc.). Examples of user devices may also include automobiles with remote communication capabilities.

There are various scenarios in which an entity, such as a government entity, may disburse fungible funds or provide vouchers, coupons, offers, or the like to citizens for a specific purpose. In one example, a government entity may increase a goods and services tax and, as a result, may want to compensate citizens for the first few years after the increase takes effect. In another example, a government entity may acknowledge that inflation has caused an increase in the price of food products and, as a result, may want to compensate citizens. In each of the examples disclosed above, and similarly for other like scenarios, an entity, such as a government entity, may disburse fungible funds to citizens, or may provide vouchers, coupons, offers, or the like to citizens. Relating to the examples disclosed above, the government entity may disburse fungible funds for use by citizens to help cover the cost of the increased goods and services tax, or to help cover the cost of food products affected by inflation. If the government entity wishes to provide a voucher, coupon, offer, or the like to citizens, as opposed to disbursing fungible funds, the government entity may offer cashback on goods and services affected by the increase in the goods and services tax, or may offer cashback on food products affected by inflation. For example, the government entity may offer 3% cashback on food products. Similarly, the government entity may offer a discount (e.g., 50% off for up to $800/month) for goods and services affected by the increase in the goods and services tax, or may offer a discount on food products affected by inflation. It should be noted that the examples disclosed herein are not so limiting. Rather, there are several scenarios in which an entity, such as a government entity, may disburse fungible funds or provide vouchers, coupons, offers, or the like to citizens for a specific purpose that may not be disclosed herein. It shall be appreciated and understood that an intent to spend fungible funds, or make use of vouchers, coupons, offers, or the like, as provided by an intent-issuing entity, is to be subject to the regulatory and legal requirements of the jurisdiction for which an intent has been issued.

Although an entity, such as a government entity, may effectively disburse fungible funds or provide vouchers, coupons, offers, or the like to citizens for a specific purpose, the entity is unable to control how such fungible funds, vouchers, coupons, offers, or the like are spent. In other words, the entity is unable to control if the fungible funds, vouchers, coupons, offers, or the like are used for their specific, or intended, purpose. That is, if the entity disburses fungible funds to help cover the cost of an increased goods and services tax, the entity is unable to control if the disbursed fungible funds are actually used to help cover the cost of the increased goods and services tax, or if the disbursed fungible funds are used for other purchases for which the funds are not intended. Likewise, if the entity disburses fungible funds to help cover the cost of food products affected by inflation, the entity is unable to control if the disbursed fungible funds are used to help pay for food products affected by inflation, or if the disbursed fungible funds are used for other purchases for which the funds are not intended.

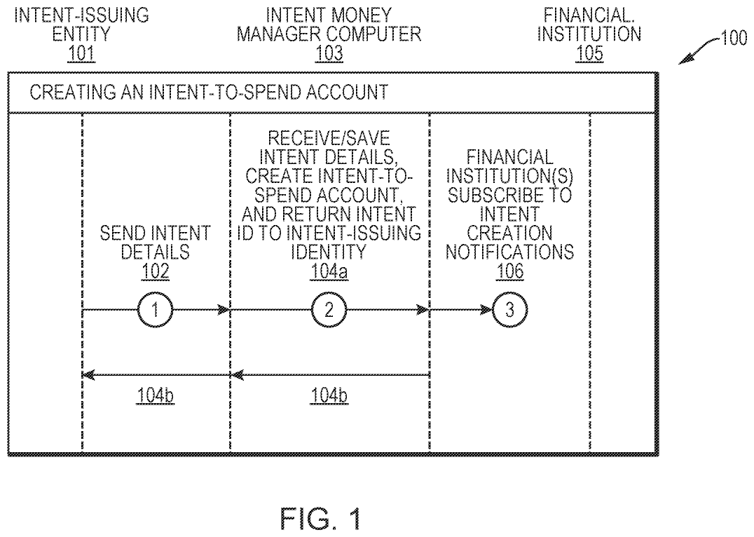

As a result, the present disclosure provides a solution which allows an entity, such as a government entity, to manage financial transactions based on an intent-to-spend fungible funds, or use a voucher, coupon, offer, or the like, based on a set of rules. The present disclosure further provides solutions for creating an intent-to-spend account and creating a prepaid payment instrument for use according to an intent-to-spend fungible funds based on a set of rules. The aforementioned solutions, as disclosed herein, make use of an intent money manager computer (IMMC), which will now be described in greater detail below with reference to each of FIGS. 1-8.

FIG. 1 is a swimlane diagram 100 illustrating a process of creating an intent-to-spend account, according to at least one aspect of the present disclosure. Creating an intent-to-spend account begins when an entity, such as an intent-issuing entity 101, sends 102 intent details to an intent money manager computer 103 (IMMC). According to at least one aspect of the present disclosure, the intent details may include a request to create an intent-to-spend account, a set of transaction rules a transaction is to follow to be eligible for fungible funds, vouchers, coupons, offers, or the like of the intent-to-spend account, a budget for the intent-to-spend account, and/or an approximate number of users for which the intent-to-spend account is intended. The IMMC 103 then receives and saves 104a the intent details in at least one database. The IMMC 103 further creates the intent-to-spend account based on the received and saved 104a intent details, and returns 104b an intent identification to the intent-issuing entity 101, where the intent identification corresponds to the newly-created intent-to-spend account. The IMMC 103 further sends an intent-to-spend account creation notification to a financial institution 105 based on the financial institution 105 having subscribed 106 to intent-to-spend account creation notifications of the IMMC 103. In other words, the financial institution 105 receives the intent-to-spend account creation notification based on a subscription to the IMMC 103 to receive intent-to-spend account creation notifications. Based on the received notification, the financial institution 105 may begin to onboard clients via at least one banking channel, such as branch banking, electronic banking, and/or self-service banking. Furthermore, the financial institution 105 may enable clients to link an existing payment instrument, such as, for example, a credit card, to the intent-to-spend account for which they are being onboarded.

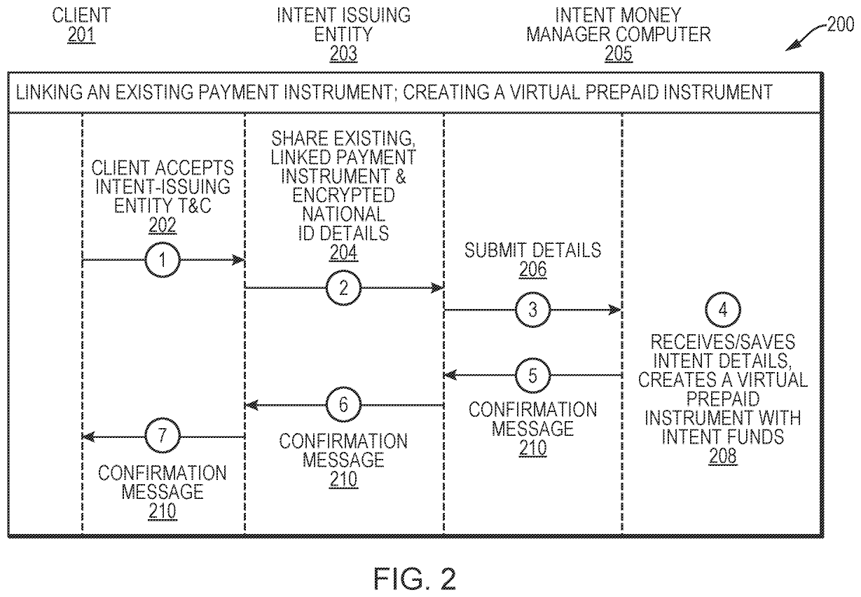

FIG. 2 is a swimlane diagram 200 illustrating a process of linking an existing payment instrument with an intent-to-spend account and creating a virtual prepaid instrument for which fungible funds of the intent-to-spend account may be deposited, according to at least one aspect of the present disclosure. The process of linking an existing payment instrument with the intent-to-spend account and creating a virtual prepaid instrument begins when the financial institution 105 starts onboarding clients via at least one banking channel. A client 201 first accepts 202 the terms and conditions of an intent-issuing entity 203. The client 201 then links an existing payment instrument to the intent-to-spend account for which the client is being onboarded, and shares 204 the linked, existing payment instrument and encrypted national identification details with the intent-issuing entity 203. According to at least one aspect of the present disclosure, the existing payment instrument may be, for example, a credit card, a debit card, a prepaid card, or another payment instrument which may be used for conducting financial transactions.

According to at least one aspect of the present disclosure, the encrypted national identification details may include an encrypted national identification number, or any similar encrypted identification information that may be associated with a single onboarded client. After receiving the linked, existing payment instrument and the encrypted national identification details, the intent-issuing entity 203 submits these, along with intent details, to an intent money manager computer 205 (IMMC).

The IMMC 205 then receives and saves 208 the intent details in at least one database. The IMMC 205 further validates the received linked, existing payment instrument and encrypted national identification details, and, based on successful validation, creates a virtual prepaid instrument for the onboarded client which is funded with fungible funds from a previously-created intent-to-spend account. The fungible funds, which are added to the virtual prepaid instrument, are then posted to the intent-to-spend account and validated against a previously-defined intent-to-spend budget. Finally, the IMMC 205 sends a confirmation message to the intent-issuing entity 203 and the client 201. According to at least one aspect of the present disclosure, the confirmation message may include details regarding the virtual prepaid instrument and the fungible funds that have been posted to the virtual prepaid instrument for use by an onboarded client.

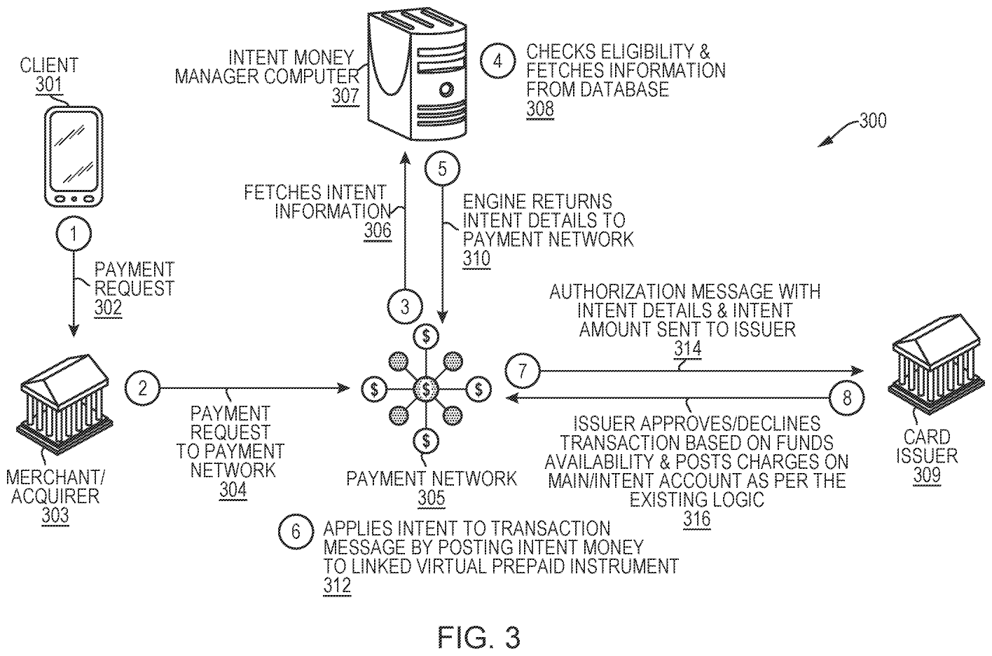

FIG. 3 is a flow diagram 300 illustrating a payment processing method with an intent money manager computer 307 (IMMC), according to at least one aspect of the present disclosure. Specifically, FIG. 3 illustrates how the IMMC 307 and an intent-to-spend account may be used in payment processing for an onboarded client. First, a client 301 sends 302 a payment request (e.g., a financial transaction) to a merchant or acquirer 303. According to at least one aspect of the present disclosure, the client 301 may send the payment request 302 by initiating a financial transaction via a payment instrument, where the payment instrument may be a physical card or a digitally-stored card in a digital wallet. The merchant, or acquirer, 303 then sends 304 the payment request to a payment network 305. The payment network 305 then fetches 306 intent information, such as a set of rules of an intent-to-spend account for which the client 301 has been onboarded, from the IMMC 307 and a database in which the intent information is stored. The IMMC 307 then checks 308 the eligibility of the payment request based on the fetched intent information. Based on a verification that the payment request is eligible, the IMMC 307 sends 310 the fetched intent information to the payment network 305. The payment network 305 then applies 312 the fetched intent information to the payment request, or transaction message, by posting applicable charges (e.g., charges that satisfy the fetched intent information) to a virtual prepaid instrument of the client 301, where the virtual prepaid instrument is linked to the intent-to-spend account. The payment network 305 then sends 314 an authorization message with the fetched intent information and the posted applicable charges to a card issuer 309 of the client 301. The card issuer 309 then approves or denies 316 the payment request based on available funds of the virtual prepaid instrument of the client 301, and posts the applicable charges to the intent-to-spend account for which the virtual prepaid instrument of the client 301 is linked. The payment request is then completed, and the applicable charges are removed from the virtual prepaid instrument of the client 301.

In order to better understand the payment processing flow, consider the following example, as described with reference to FIG. 3. Assume that a client 301 has been onboarded for an intent-to-spend account, where the intent-to-spend account provides the client 301 with 50% off food products for up to $800/month. Assume that the client 301 has submitted a payment request (e.g., a financial transaction) to a merchant, or acquirer, 303 for a transaction of $100.00, where $30.00 of the transaction corresponds to food products. The merchant or acquirer 303 then sends 304 the payment request to a payment network 305. The payment network 305 then fetches 306 intent information, such as a set of rules of an intent-to-spend account for which the client 301 has been onboarded, from the IMMC 307 and a database in which the intent information has been stored. In this example, the fetched intent information defines that the client 301 may receive 50% off food products for up to $800/month. The IMMC 307 then checks 308 the eligibility of the payment request based on the fetched intent information. That is, the IMMC 307 determines if the payment request is eligible for the benefit (e.g., 50% off food products for up to $800/month) as defined by the fetched intent information. In this example, the IMMC 307 determines that $30.00 of the payment request is eligible for the benefit, while $70.00 of the payment request is ineligible for the benefit. The IMMC 307 then sends 310 the fetched intent information to the payment network 305.

The payment network 305 then applies 312 the fetched intent information to the payment request, or transaction message, by posting applicable charges (e.g., charges that satisfy the fetched intent information) to a virtual prepaid instrument of the client 301, where the virtual prepaid instrument is linked to the intent-to-spend account. In this example, the client receives the benefit of 50% off food products for up to $800/month. Thus, for the eligible $30.00 of the payment request, the client will receive a discount of $15.00. As such, $15.00 of the eligible $30.00 will be charged to the virtual prepaid instrument of the client 301, while the remaining $15.00 of the eligible $30.00 will be charged to an existing payment instrument of the client 301, such as an existing credit card, debit card, prepaid card, or the like which may be used for conducting financial transactions. Similarly, the remaining $70.00 that is ineligible for the benefit will be charged to the existing payment instrument of the client 301. The payment network 305 then sends 314 an authorization message with the fetched intent information and the posted applicable charges (e.g., $15.00) to a card issuer 309 of the client 301.

The card issuer 309 then approves or denies 316 the payment request based on available funds of the virtual prepaid instrument of the client 301. In this example, the virtual prepaid instrument of the client 301 is funded with $800/month for providing 50% off food products. Additionally, in this example, it is assumed that the client has not yet taken advantage of the benefit, and thus has $800 remaining for the current month. Thus, in this example, the card issuer 309 approves the payment request based on the virtual prepaid instrument of the client 301 having sufficient funds for completing the payment request. The card issuer 309 further posts the applicable charges (e.g., $15.00) to the intent-to-spend account for which the virtual prepaid instrument of the client 301 is linked. The payment request is then completed, and the applicable charges are removed from the virtual prepaid instrument of the client 301. In this example, the payment request is completed and the client 301 is only charged $15.00 to their existing payment instrument for their food products despite having purchased $30.00 worth of food products.

It should be noted that the aforementioned example, as described with reference to FIG. 3, is merely representative of one possible scenario and it not meant to limit the scope of the present disclosure. There are several other scenarios in which a client may utilize an IMMC and an intent-to-spend account to claim the benefit of fungible funds, vouchers, coupons, offers, or the like as disbursed by an entity, such as a government entity.

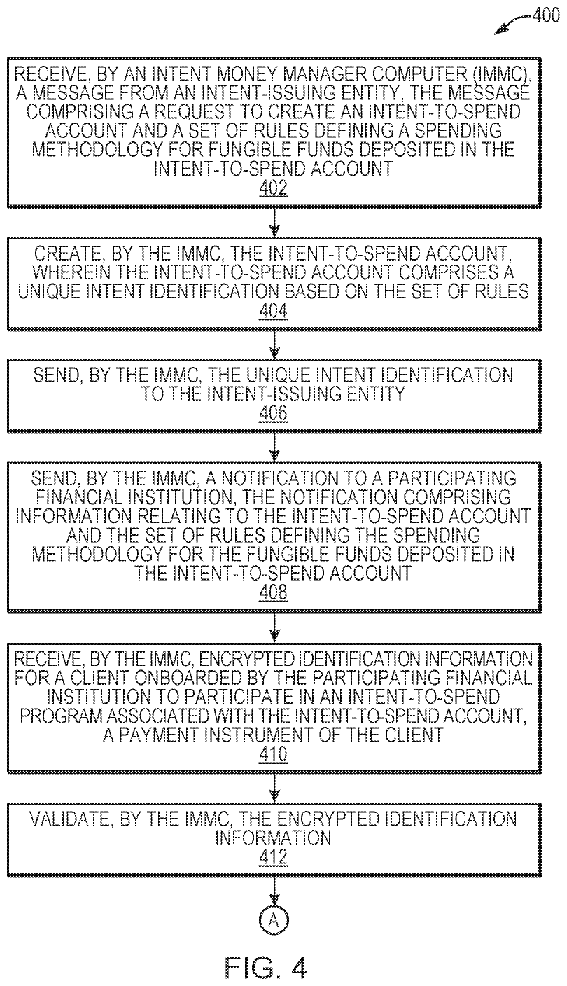

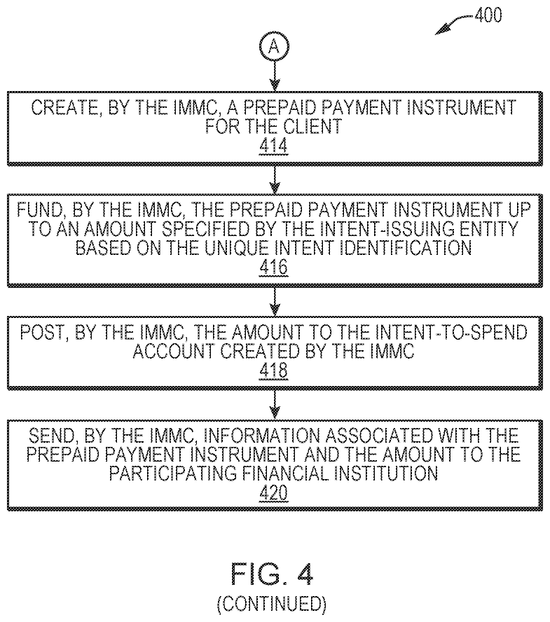

FIG. 4 illustrates a method 400 for managing financial transactions based on an intent-to-spend fungible funds based on a set of rules, according to at least one aspect of the present disclosure. According to at least one aspect of the present disclosure, the method 400 of FIG. 4 will now be described together with swimlane diagrams 100 and 200 shown in FIGS. 1 and 2, respectively. Accordingly, with reference now to FIGS. 1, 2, and 4, in at least one aspect, according to the method 400, the IMMC 103/205 receives 402 a message from an intent-issuing entity 101/203, the message comprising a request to create an intent-to-spend account and a set of rules defining a spending methodology for fungible funds deposited in the intent-to-spend account. The IMMC 103/205 then creates 404 the intent-to-spend account. In one aspect, the intent-to-spend account comprises a unique intent identification based on the set of rules, and sends 406 the unique intent identification to the intent-issuing entity 101/203. The IMMC 103/205 further sends 408 a notification to a participating financial institution 105, the notification comprising information relating to the intent-to-spend account and the set of rules defining the spending methodology for the fungible funds deposited in the intent-to-spend account. The IMMC 103/205 further receives 410 encrypted identification information for a client 201 onboarded by the participating financial institution 105 to participate in an intent-to-spend program associated with the intent-to-spend account, information associated with a payment instrument of the client 201. In one aspect, the payment instrument is linked to the intent-to-spend account, and information associated with the intent-to-spend account and the set of rules defining the spending methodology. The IMMC 103/205 further validates 412 the encrypted identification information. Based on a successful validation 412 of the encrypted identification information, the IMMC 103/205 further creates 414 a prepaid payment instrument for the client 201. The IMMC 103/205 further funds 416 the prepaid payment instrument up to an amount specified by the intent-issuing entity 101/203 based on the unique intent identification. The IMMC 103/205 further posts 418 the amount to the intent-to-spend account created by the IMMC 103/205. Finally, the IMMC 103/205 sends 420 information associated with the prepaid payment instrument and the amount to the participating financial institution 105. Although each of the functions 402, 404, 406, 408, 410, 412, 414, 416, 418, 420 of the method 400 have been described herein as being performed by the IMMC 103/205, it shall be appreciated that each of the functions 402, 404, 406, 408, 410, 412, 414, 416, 418, 420 of the method 400 may be carried out by any suitable element configured to manage financial transactions based on an intent-to-spend fungible funds based on a set of rules.

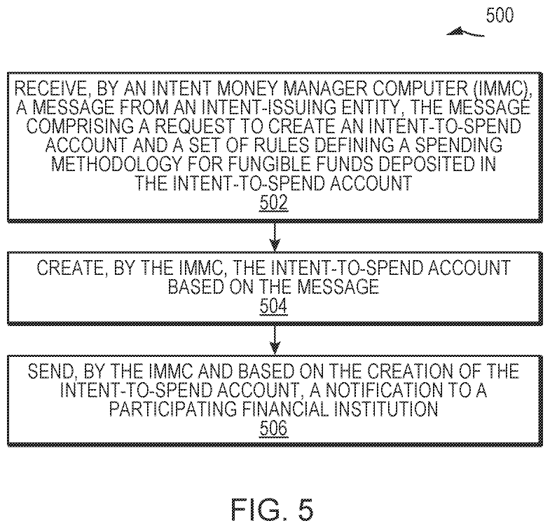

FIG. 5 illustrates a method 500 for creating an intent-to-spend account, according to at least one aspect of the present disclosure. According to at least one aspect of the present disclosure, the method 500 of FIG. 5 will now be described together with swimlane diagram 100 shown in FIG. 1. Accordingly, with reference now to FIGS. 1 and 5, in at least one aspect, according to the method 500, the IMMC 103 receives 502 a message from an intent-issuing entity 103, the message comprising a request to create an intent-to-spend account and a set of rules defining a spending methodology for fungible funds deposited in the intent-to-spend account. The IMMC 103 then creates 504 the intent-to-spend account based on the message. Finally, the IMMC 103, based on the creating of the intent-to-spend account, sends 506 a notification to a participating financial institution 105. In one aspect, the notification comprises information relating to the intent-to-spend account and the set of rules defining the spending methodology for the fungible funds deposited in the intent-to-spend account. In one aspect, the participating financial institution 105, upon receipt of the notification, enables users to enroll in an intent-to-spend program associated with the intent-to-spend account via at least one banking channel. Although each of the functions 502, 504, 506 of the method 500 have been described herein as being performed by the IMMC 103, it shall be appreciated that each of the functions 502, 504, 506 of the method 500 may be carried out by any suitable element configured to create an intent-to-spend account.

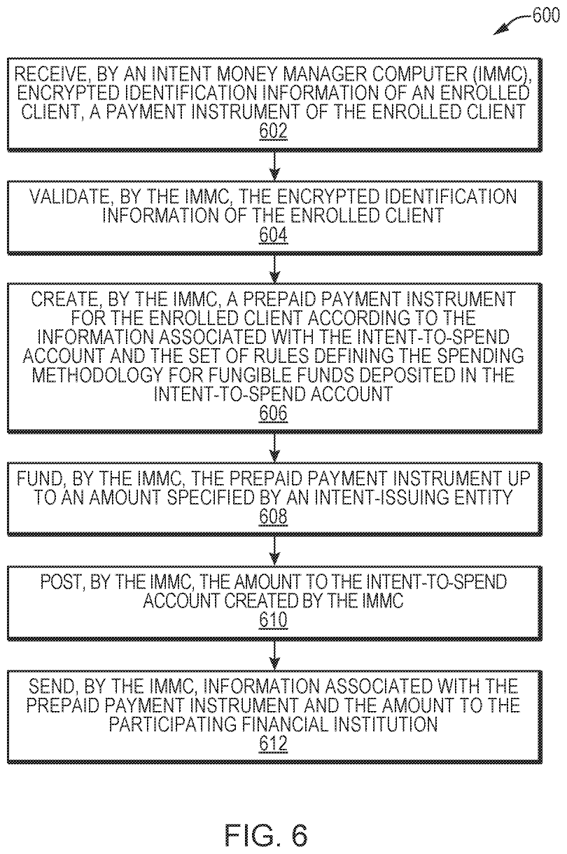

FIG. 6 illustrates a method 600 for creating a prepaid payment instrument for use according to an intent-to-spend fungible funds based on a set of rules, according to at least one aspect of the present disclosure. According to at least one aspect of the present disclosure, the method 600 of FIG. 6 will not be described together with swimlane diagram 200 shown in FIG. 2. Accordingly, with reference now to FIGS. 2 and 6, in at least one aspect, according to the method 600, the IMMC 205 receives 602 encrypted identification information of an enrolled client 201, a payment instrument of the enrolled client 201. In one aspect, the payment instrument is linked to the intent-to-spend account, and information associated with the intent-to-spend account and a set of rules defining a spending methodology for fungible funds deposited in the intent-to-spend account. The IMMC 205 then validates 604 the encrypted identification information of the enrolled client 201. The IMMC 205 further creates 606 a prepaid payment instrument for the enrolled client according to the information associated with the intent-to-spend account and the set of rules defining the spending methodology for fungible funds deposited in the intent-to-spend account. The IMMC 205 further funds 608 the prepaid payment instrument up to an amount specified by an intent-issuing entity 203. The IMMC 205 further posts 610 the amount to the intent-to-spend account created by the IMMC 205. Finally, the IMMC 205 sends 612 information associated with the prepaid payment instrument and the amount to the participating financial institution 203. Although each of the functions 602, 604, 606, 608, 610, 612 of the method 600 have been described herein as being performed by the IMMC 205, it shall be appreciated that each of the functions 602, 604, 606, 608, 610, 612 of the method 600 may be carried out by any suitable element configured to create a prepaid payment instrument for use according to an intent-to-spend fungible funds based on a set of rules.

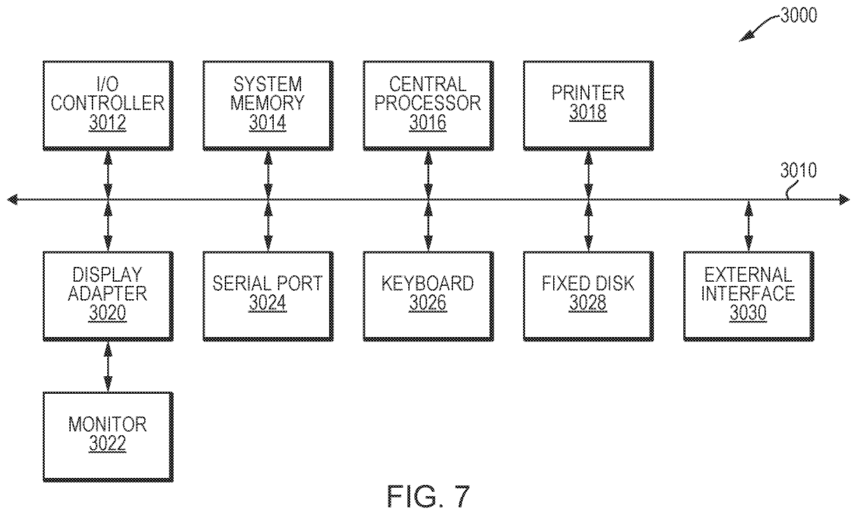

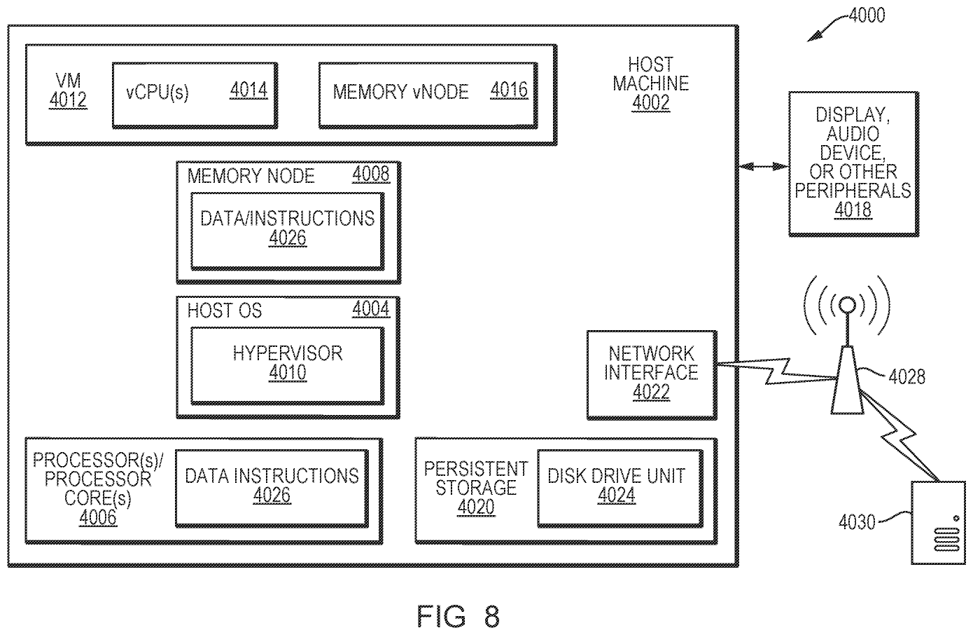

The aforementioned systems and methods to manage financial transactions based on an intent-to-spend fungible funds based on a set of rules, creating an intent-to-spend account, and creating a prepaid payment instrument for use according to an intent-to-spend fungible funds based on a set of rules, as described above with respect to each of FIGS. 1-6, may include, or make use of, a number of computer apparatuses, computer systems, or the like. In other words, in order to utilize the systems and methods disclosed herein, at least one of a computer apparatus, computer system, or the like may be implemented. Each of these computer apparatuses, computer systems, or the like are described in greater detail below with respect to the computer apparatus 3000 shown in FIG. 7 and the example computer system 4000 shown in FIG. 8, which provides a connection between the solution disclosed herein and how such a solution may be implemented within a business entity, such as a payment network, a processing network, a payment processing network, or the like.

FIG. 7 is a block diagram of a computer apparatus 3000 with data processing subsystems or components, according to at least one aspect of the present disclosure. The subsystems shown in FIG. 7 are interconnected via a system bus 3010. Additional subsystems such as a printer 3018, keyboard 3026, fixed disk 3028 (or other memory comprising computer-readable media), monitor 3022, which is coupled to a display adapter 3020, and others are shown. Peripherals and input/output (I/O) devices, which couple to an I/O controller 3012 (which can be a processor or other suitable controller), can be connected to the computer system by any number of means known in the art, such as a serial port 3024. For example, the serial port 3024 or external interface 3030 can be used to connect the computer apparatus to a wide area network such as the Internet, a mouse input device, or a scanner. The interconnection via system bus allows the central processor 3016 to communicate with each subsystem and to control the execution of instructions from system memory 3014 or the fixed disk 3028, as well as the exchange of information between subsystems. The system memory 3014 and/or the fixed disk 3028 may embody a computer-readable medium.

FIG. 8 is a diagrammatic representation of an example computer system 4000 that includes a host machine 4002 within which a set of instructions to perform any one or more of the methodologies discussed herein may be executed, according to at least one aspect of the present disclosure. In various aspects, the host machine 4002 operates as a standalone device or may be connected (e.g., networked) to other machines. In a networked deployment, the host machine 4002 may operate in the capacity of a server or a client machine in a server-client network environment, or as a peer machine in a peer-to-peer (or distributed) network environment. The host machine 4002 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 4000 includes the host machine 4002, running a host operating system (OS) 4004 on a processor or multiple processor(s)/processor core(s) 4006 (e.g., a central processing unit (CPU), a graphics processing unit (GPU), or both), and various memory nodes 4008. The host OS 4004 may include a hypervisor 4010 which is able to control the functions and/or communicate with a virtual machine (“VM”) 4012 running on machine readable media. The VM 4012 also may include a virtual CPU or vCPU 4014. The memory nodes 4008 may be linked or pinned to virtual memory nodes or vNodes 4016. When the memory node 4008 is linked or pinned to a corresponding vNode 4016, then data may be mapped directly from the memory nodes 4008 to their corresponding vNodes 4016.

All the various components shown in host machine 4002 may be connected with and to each other, or communicate to each other via a bus (not shown) or via other coupling or communication channels or mechanisms. The host machine 4002 may further include a video display, audio device or other peripherals 4018 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker,) a persistent storage device 4020 (also referred to as disk drive unit), and a network interface device 4022. The host machine 4002 may further include a data encryption module (not shown) to encrypt data. The components provided in the host machine 4002 are those typically found in computer systems that may be suitable for use with aspects of the present disclosure and are intended to represent a broad category of such computer components that are known in the art. Thus, the system 4000 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 4024 also may be a Solid-state Drive (SSD), a hard disk drive (HDD) or other includes a computer or machine-readable medium on which is stored one or more sets of instructions and data structures (e.g., data/instructions 4026) embodying or utilizing any one or more of the methodologies or functions described herein. The data/instructions 4026 also may reside, completely or at least partially, within the main memory node 4008 and/or within the processor(s) 4006 during execution thereof by the host machine 4002. The data/instructions 4026 may further be transmitted or received over a network 4028 via the network interface device 4022 utilizing any one of several well-known transfer protocols (e.g., Hyper Text Transfer Protocol (HTTP)).

The processor(s) 4006 and memory nodes 4008 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 4002 and that causes the host machine 4002 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AlN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 4030 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 4002, with each server 4030 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object-oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Examples of the systems and methods according to various aspects of the present disclosure are provided below in the following numbered clauses. Any aspect of a system or method may include any one or more than one, and any combination of, the numbered clauses described below.

Clause 1: A computer-implemented method for managing financial transactions based on an intent-to-spend fungible funds based on a set of rules, the computer-implemented method comprising: receiving, by an intent money manager computer, a message from an intent-issuing entity, the message comprising a request to create an intent-to-spend account and a set of rules defining a spending methodology for fungible funds deposited in the intent-to-spend account; creating, by the intent money manager computer, the intent-to-spend account. In one aspect, the intent-to-spend account comprises a unique intent identification based on the set of rules; sending, by the intent money manager computer, the unique intent identification to the intent-issuing entity; sending, by the intent money manager computer, a notification to a participating financial institution, the notification comprising information relating to the intent-to-spend account and the set of rules defining the spending methodology for the fungible funds deposited in the intent-to-spend account; receiving, by the intent money manager computer, encrypted identification information for a client onboarded by the participating financial institution to participate in an intent-to-spend program associated with the intent-to-spend account, information associated with a payment instrument of the client, wherein the payment instrument is linked to the intent-to-spend account, and information associated with the intent-to-spend account and the set of rules defining the spending methodology; validating, by the intent money manager computer, the encrypted identification information; based on a successful validation: creating, by the intent money manager computer, a prepaid payment instrument for the client; funding, by the intent money manager computer, the prepaid payment instrument up to an amount specified by the intent-issuing entity based on the unique intent identification; posting, by the intent money manager computer, the amount to the intent-to-spend account created by the intent money manager computer; and sending, by the intent money manager computer, information associated with the prepaid payment instrument and the amount to the participating financial institution.

Clause 2: The computer-implemented method according to Clause 1, wherein the message further comprises at least one of a budget for the intent-to-spend account or a number of targeted users of the intent-to-spend account.

Clause 3: The computer-implemented method according to either of Clauses 1 or 2, further comprising, based on the successful validation, validating, by the intent money manager computer, the posted amount against the budget of the intent-to-spend account.

Clause 4: The computer-implemented method according to any of Clauses 1-3, wherein the intent-issuing entity is a governing entity.

Clause 5: The computer-implemented method according to any of Clauses 1-4, wherein the payment instrument is at least one of a physical payment card or a digital payment card stored in a digital wallet.

Clause 6: The computer-implemented method according to any of Clauses 1-5, wherein the prepaid payment instrument is a virtual payment card, and wherein the prepaid payment instrument is not visible to the client.

Clause 7: The computer-implemented method according to any of Clauses 1-6, wherein the encrypted identification information comprises a national identification.

Clause 8: A computer-implemented method for creating an intent-to-spend account, the computer-implemented method comprising: receiving, by an intent money manager computer, a message from an intent-issuing entity, the message comprising a request to create an intent-to-spend account and a set of rules defining a spending methodology for fungible funds deposited in the intent-to-spend account; creating, by the intent money manager computer, the intent-to-spend account based on the message; and sending, by the intent money manager computer and based on the creating of the intent-to-spend account, a notification to a participating financial institution, wherein the notification comprises information relating to the intent-to-spend account and the set of rules defining the spending methodology for the fungible funds deposited in the intent-to-spend account, and wherein the participating financial institution, upon receipt of the notification, enables users to enroll in an intent-to-spend program associated with the intent-to-spend account via at least one banking channel.

Clause 9: The computer-implemented method according to Clause 8, wherein the message further comprises at least one of a budget for the intent-to-spend account or a number of targeted users of the intent-to-spend account.

Clause 10: The computer-implemented method according to either of Clauses 8 or 9, wherein the intent-issuing entity is a governing entity.

Clause 11: The computer-implemented method according to any of Clauses 8-10, wherein users are to accept a terms and conditions agreement before enrollment in the intent-to-spend program associated with the intent-to-spend account.

Clause 12: The computer-implemented method according to any of Clauses 8-11, wherein the at least one banking channel is one of branch banking, electronic banking, or self-service banking.

Clause 13: The computer-implemented method according to any of Clauses 8-12, wherein the set of rules further define at least one of a number or a type of transactions eligible for an offer.

Clause 14: The computer-implemented method according to any of Clauses 8-13, wherein the participating financial institution receives the notification based on a subscription to the intent money manager computer.

Clause 15: A computer-implemented method for creating a prepaid payment instrument for use according to an intent-to-spend fungible funds based on a set of rules, the computer-implemented method comprising: based on a participating financial institution receiving a notification of an intent-to-spend account being created and enabling users to enroll in an intent-to-spend program associated with the intent-to-spend account: receiving, by an intent money manager computer, encrypted identification information of an enrolled client, information associated with a payment instrument of the enrolled client, wherein the payment instrument is linked to the intent-to-spend account, and information associated with the intent-to-spend account and a set of rules defining a spending methodology for fungible funds deposited in the intent-to-spend account; validating, by the intent money manager computer, the encrypted identification information of the enrolled client; based on a successful validation: creating, by the intent money manager computer, a prepaid payment instrument for the enrolled client according to the information associated with the intent-to-spend account and the set of rules defining the spending methodology for fungible funds deposited in the intent-to-spend account; funding, by the intent money manager computer, the prepaid payment instrument up to an amount specified by an intent-issuing entity; posting, by the intent money manager computer, the amount to the intent-to-spend account created by the intent money manager computer; and sending, by the intent money manager computer, information associated with the prepaid payment instrument and the amount to the participating financial institution.

Clause 16: The computer-implemented method according to Clause 15, further comprising, based on the successful validation, validating, by the intent money manager computer, the posted amount against a budget of the intent-to-spend account.

Clause 17: The computer-implemented method according to either of Clauses 15 or 16, wherein the intent-issuing entity is a governing entity.

Clause 18: The computer-implemented method according to any of Clauses 15-17, wherein the payment instrument is at least one of a physical payment card or a digital payment card stored in a digital wallet.

Clause 19: The computer-implemented method according to any of Clauses 15-18, wherein the prepaid payment instrument is a virtual payment card, and wherein the prepaid payment instrument is not visible to the enrolled client.

Clause 20: The computer-implemented method according to any of Clauses 15-19, wherein the encrypted identification information comprises a national identification.

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer-readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Any of the software components or functions described in this application, may be implemented as software code to be executed by a processor using any suitable computer language such as, for example, Python, Java, C++ or Perl using, for example, conventional or object-oriented techniques. The software code may be stored as a series of instructions, or commands on a computer-readable medium, such as RAM, ROM, a magnetic medium such as a hard-drive or a floppy disk, or an optical medium such as a CD-ROM. Any such computer-readable medium may reside on or within a single computational apparatus, and may be present on or within different computational apparatuses within a system or network.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer-readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the present disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted to be prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A computer-implemented method for managing financial transactions based on an intent-to-spend fungible funds based on a set of rules, the computer-implemented method comprising:
receiving, by an intent money manager computer, a message from an intent-issuing entity, the message comprising a request to create an intent-to-spend account and a set of rules defining a spending methodology for fungible funds deposited in the intent-to-spend account;
creating, by the intent money manager computer, the intent-to-spend account, wherein the intent-to-spend account comprises a unique intent identification based on the set of rules;
sending, by the intent money manager computer, the unique intent identification to the intent-issuing entity;
sending, by the intent money manager computer, a notification to a participating financial institution, the notification comprising information relating to the intent-to-spend account and the set of rules defining the spending methodology for the fungible funds deposited in the intent-to-spend account;
receiving, by the intent money manager computer, encrypted identification information for a client onboarded by the participating financial institution to participate in an intent-to-spend program associated with the intent-to-spend account, information associated with a payment instrument of the client, wherein the payment instrument is linked to the intent-to-spend account, and information associated with the intent-to-spend account and the set of rules defining the spending methodology;
validating, by the intent money manager computer, the encrypted identification information;
based on a successful validation:
creating, by the intent money manager computer, a prepaid payment instrument for the client;
funding, by the intent money manager computer, the prepaid payment instrument up to an amount specified by the intent-issuing entity based on the unique intent identification;
posting, by the intent money manager computer, the amount to the intent-to-spend account created by the intent money manager computer; and
sending, by the intent money manager computer, information associated with the prepaid payment instrument and the amount to the participating financial institution.

2. The computer-implemented method of claim 1, wherein the message further comprises at least one of a budget for the intent-to-spend account or a number of targeted users of the intent-to-spend account.

3. The computer-implemented method of claim 2, further comprising, based on the successful validation, validating, by the intent money manager computer, the posted amount against the budget of the intent-to-spend account.

4. The computer-implemented method of claim 1, wherein the intent-issuing entity is a governing entity.

5. The computer-implemented method of claim 1, wherein the payment instrument is at least one of a physical payment card or a digital payment card stored in a digital wallet.

6. The computer-implemented method of claim 1, wherein the prepaid payment instrument is a virtual payment card, and wherein the prepaid payment instrument is not visible to the client.

7. The computer-implemented method of claim 1, wherein the encrypted identification information comprises a national identification.

8. A computer-implemented method for creating an intent-to-spend account, the computer-implemented method comprising:
receiving, by an intent money manager computer, a message from an intent-issuing entity, the message comprising a request to create an intent-to-spend account and a set of rules defining a spending methodology for fungible funds deposited in the intent-to-spend account;
creating, by the intent money manager computer, the intent-to-spend account based on the message; and
sending, by the intent money manager computer and based on the creating of the intent-to-spend account, a notification to a participating financial institution, wherein the notification comprises information relating to the intent-to-spend account and the set of rules defining the spending methodology for the fungible funds deposited in the intent-to-spend account, and wherein the participating financial institution, upon receipt of the notification, enables users to enroll in an intent-to-spend program associated with the intent-to-spend account via at least one banking channel.

9. The computer-implemented method of claim 8, wherein the message further comprises at least one of a budget for the intent-to-spend account or a number of targeted users of the intent-to-spend account.

10. The computer-implemented method of claim 8, wherein the intent-issuing entity is a governing entity.

11. The computer-implemented method of claim 8, wherein users are to accept a terms and conditions agreement before enrollment in the intent-to-spend program associated with the intent-to-spend account.

12. The computer-implemented method of claim 8, wherein the at least one banking channel is one of branch banking, electronic banking, or self-service banking.

13. The computer-implemented method of claim 8, wherein the set of rules further define at least one of a number or a type of transactions eligible for an offer.

14. The computer-implemented method of claim 8, wherein the participating financial institution receives the notification based on a subscription to the intent money manager computer.

15. A computer-implemented method for creating a prepaid payment instrument for use according to an intent-to-spend fungible funds based on a set of rules, the computer-implemented method comprising:
based on a participating financial institution receiving a notification of an intent-to-spend account being created and enabling users to enroll in an intent-to-spend program associated with the intent-to-spend account:
receiving, by an intent money manager computer, encrypted identification information of an enrolled client, information associated with a payment instrument of the enrolled client, wherein the payment instrument is linked to the intent-to-spend account, and information associated with the intent-to-spend account and a set of rules defining a spending methodology for fungible funds deposited in the intent-to-spend account;
validating, by the intent money manager computer, the encrypted identification information of the enrolled client;
based on a successful validation:
creating, by the intent money manager computer, a prepaid payment instrument for the enrolled client according to the information associated with the intent-to-spend account and the set of rules defining the spending methodology for fungible funds deposited in the intent-to-spend account;
funding, by the intent money manager computer, the prepaid payment instrument up to an amount specified by an intent-issuing entity;
posting, by the intent money manager computer, the amount to the intent-to-spend account created by the intent money manager computer; and
sending, by the intent money manager computer, information associated with the prepaid payment instrument and the amount to the participating financial institution.

16. The computer-implemented method of claim 15, further comprising, based on the successful validation, validating, by the intent money manager computer, the posted amount against a budget of the intent-to-spend account.

17. The computer-implemented method of claim 15, wherein the intent-issuing entity is a governing entity.

18. The computer-implemented method of claim 15, wherein the payment instrument is at least one of a physical payment card or a digital payment card stored in a digital wallet.

19. The computer-implemented method of claim 15, wherein the prepaid payment instrument is a virtual payment card, and wherein the prepaid payment instrument is not visible to the enrolled client.

20. The computer-implemented method of claim 15, wherein the encrypted identification information comprises a national identification.
